(19) United States
(12) Patent Application Publication
(10) Pub. No.: US 2026/0329080 A1
(43) Pub. Date: Oct. 22, 2026

(54) DISPLAY SYSTEM FOR A VEHICLE HAVING TWO DIFFERENT OPERATING MODES

(71) Applicant: SAINT-GOBAIN SEKURIT FRANCE, Thourotte (FR)

(72) Inventors: Michele CAPPUCCILLI, HERZOGENRATH (DE); Oliver GIER, HERZOGENRATH (DE); Thibaut HEITZ, HERZOGENRATH (DE); Andreas GOMER, HERZOGENRATH (DE)

(21) Appl. No.: 19/108,961

(22) PCT Filed: Aug. 7, 2023
(86) PCT No.: PCT/EP2023/071771

§ 371 Date: Mar. 5, 2025

(30) Foreign Application Priority Data
Sep. 6, 2022 (EP) 22194118.0

(51) Int. Cl. G02B 27/01; B32B 17/10; B60K 35/231; B60K 35/28; B60K 35/81; G02F 1/157

(52) U.S. Cl. CPC G02B 27/0101; B32B 17/10036; B32B 17/10513; B60K 35/231; B60K 35/28; B60K 35/81; G02B 27/0179; G02F 1/157; B32B 2250/02; B32B 2307/204; B32B 2307/41; B32B 2307/412; B32B 2307/416; B32B 2457/20; B32B 2605/00; B60K 2360/1526; B60K 2360/164; B60K 2360/186; G02B 2027/0181; G02B 2207/123

(57) ABSTRACT

A display system for a vehicle, includes a windscreen having a transparent see-through region and an opaque masking region, and a screen which is directed at a display area arranged in the masking region, wherein the windscreen is equipped with a reflection layer in the display area which is suitable for reflecting the radiation from the screen in order to generate a display image, and wherein the screen is suitable for operation in a first operating mode and in a second operating mode, wherein the screen emits light within a first angular range in the first operating mode and emits light within a second angular range in the second operating mode, wherein the first angular range is smaller than the second angular range.

The invention relates to a display system for a vehicle and to a vehicle equipped therewith.

Windscreen for vehicles, in particular motor vehicles, such as passenger cars, are designed as composite panes (laminated safety glass) which consist of an outer pane and an inner pane which are laminated to one another via a thermoplastic intermediate layer. They typically have an opaque masking region which is designed as a circumferential edge region and surrounds a central see-through region. The opaque masking region serves primarily to protect the adhesive used for bonding the windscreen to the vehicle body from UV radiation. If the windscreen is equipped with electrical functions (for example a heating function), the electrical connections required for this can also be concealed in the masking region. The masking region is typically formed by a black cover imprintment on the surface of the outer pane facing the intermediate layer.

It has been proposed to use the opaque masking region as a display surface for a display system. To this end, the display area is provided with a reflective layer and irradiated with an imaging unit, for example a screen or a projector. This on the reflective layer of the imaging unit can be perceived by a user, in particular the driver, as a display image. By way of example, reference is made to DE102009020824A1, WO2022073894A1 and WO2022073860A1.

In this way, displays for the driver, which have previously been located in the area of the dashboard, can be displayed on the windscreen itself. This is, on the one hand, aesthetically pleasing and, on the other hand, increases driving safety because the driver has to divert their gaze less far away from the roadway in order to read the display. Examples of such displays are driving speed, time of day, engine speed, the display of the navigation system, information about speed restrictions (traffic sign recognition), the image from a rear-facing camera and various status indicators regarding the state of the vehicle.

In one development, such a display system can also be provided for the front-seat passenger. For them, entertainment content can be displayed on the windscreen, for example. However, there is the risk that the driver is disturbed or distracted by the display system of the front-seat passenger, which impairs traffic safety. There is therefore a need for display systems of the type mentioned at the outset which display information for the front-seat passenger without the driver being distracted as a result.

WO2019034557A1 discloses a screen which can be operated in two different operating modes, specifically a free viewing mode and a restricted viewing mode. In the free viewing mode, the light from the screen is emitted over a wider angular range than in the restricted viewing mode. The screen is an LCD screen, which comprises two planar backlights with different radiation angular ranges. The user can switch on one of the two backlights to activate the desired operating mode.

The object of the present invention is to provide an improved display system for a vehicle. The display system is to be suitable for realising a display for the front-seat passenger of the vehicle without the driver being distracted or disturbed thereby. Conversely, the display for the front passenger is, however, intended to be visible to the driver if this is desired.

The object of the present invention is achieved according to the invention by a display system according to Claim 1. Preferred embodiments result from the dependent claims.

The display system according to the invention for a vehicle comprises a windscreen and (at least) one screen. The windscreen has a transparent see-through region and an opaque masking region. The screen is directed at a display area, which is arranged in the masking region of the windscreen. The windscreen is equipped in the display area with a reflection layer which is suitable for reflecting the radiation of the screen (at least partially), whereby a display image is generated.

According to the invention, the screen is suitable for operation in a first operating mode and in a second operating mode. In the first operating mode, the screen emits light within a first angular range; in the second operating mode, the screen emits light within a second angular range. The first angular range is smaller than the second angular range.

The user can switch between the first operating mode and the second operating mode of the screen. In the first operating mode, a restricted viewing mode is provided due to the smaller angular range, while in the second operating mode, a free or unrestricted viewing mode is provided due to the larger angular range. If the display system is assigned to the front passenger, the first operating mode can be selected if the display is not to distract the driver and is therefore only intended to be visible to the front passenger. However, if the driver also wants to see the display, the second operating mode can be selected. These are great advantages of the present invention.

The windscreen is provided for a vehicle and can therefore also be referred to as a vehicle windscreen. In a preferred embodiment, it is the windscreen of a motor vehicle, in particular of a passenger car or lorry.

The windscreen is typically designed as a composite pane and comprises an outer pane and an inner pane which are connected to one another via a thermoplastic intermediate layer. The windscreen is provided for separating the interior (vehicle interior) from the external environment in the window opening, facing forward (in relation to the direction of travel), of a vehicle. In the context of the invention, inner pane means the pane of the windscreen facing the interior. Outer pane means the pane facing the external environment.

The windscreen has an upper edge and a lower edge and two side edges extending between them. Upper edge means the edge intended to point upwards in the installed position. Lower edge means the edge intended to point downward in the installed position. The upper edge is often also referred to as the roof edge, and the lower edge is often also referred to as the engine edge.

The outer pane and the inner pane each have an outer and an interior-side surface and a circumferential side edge surface extending between them. In the sense of the invention, the outer-side surface means the main surface which is intended to face the external environment when installed. In the sense of the invention, the interior-side surface means the main surface which is intended to face the interior when installed. The interior-side surface of the outer pane and the outer-side surface of the inner pane face one another and are connected to one another by the thermoplastic intermediate layer.

The outer pane and the inner pane are preferably glass panes, particularly preferably made of soda-lime glass, as is customary for window panes. However, one or both of the panes can also be manufactured from other types of glass, for example quartz glass, borosilicate glass or aluminosilicate glass, or from rigid clear plastics, for example polycarbonate or polymethyl methacrylate. The panes can be clear or also tinted or coloured. The thicknesses of the outer pane and the inner pane are, independently of one another, preferably from 0.5 mm to 5 mm, particularly preferably from 1 mm to 3 mm.

The thermoplastic intermediate layer (with the exception of any embedded functional films which are frequently formed on the basis of PET) is preferably formed on the basis of polyvinyl butyral (PVB), ethylene vinyl acetate (EVA) or polyurethane (PU) or from mixtures or copolymers or derivatives thereof, particularly preferably on the basis of PVB. The intermediate layer is typically formed from at least one thermoplastic film (connecting film), in particular based on PVB, EVA or PU. This means that the film consists largely of the said polymer (proportion greater than 50 wt. %). Apart from the polymer, the film can contain further additives, in particular plasticisers. If the reflection layer is designed as a reflection film and is embedded in the intermediate layer, the intermediate layer will preferably comprise, in addition to this reflection film, at least two connecting layers (inner and outer connecting layers, wherein the inner connecting layer faces the inner pane and the outer connecting layer faces the outer pane), wherein each of the connecting layers is typically formed from at least one connecting film, in particular on the basis of PVB, EVA or PU. The reflection film is arranged between the connecting layers. The thickness of the connecting film (or each connecting film, if several are present) is preferably from 0.2 mm to 1 mm. For example, PVB films with standard thicknesses of 0.38 mm or 0.76 mm can be used. Instead of films, polymeric coatings can also be used, in particular if the thermoplastic layer in question is to be formed very thin, for example with a thickness from 0.005 mm to 0.1 mm or from 0.02 mm to 0.07 mm.

The windscreen has an opaque masking region and a transparent see-through region. In the context of the invention, masking region means a region of the windscreen through which a view is not possible. The light transmission of the masking region is less than 10%, preferably less than 5%, particularly preferably less than 2% and very particularly preferably substantially 0%. In the context of the invention, a see-through region refers to a region of the windscreen which enables a view through the windscreen and is intended for seeing through it. The see-through region is therefore transparent. The light transmission of the see-through region is preferably at least 70%. Light transmission means the total transmission, determined by the method defined by ECE-R 43, Appendix 3, Section 9.1, for testing the light transmission of motor vehicle panes.

In a typical embodiment, the masking region surrounds the see-through region in a frame-like manner. The masking region is thus arranged circumferentially around the see-through region. Typically, the masking region forms the circumferential edge region of the windscreen and adjoins the side edge of the windscreen. In a preferred embodiment, the masking region is therefore arranged in a circumferential edge region of the windscreen and surrounds the see-through region.

In a preferred embodiment, the display area is arranged in a section of the masking region adjoining the lower edge of the windscreen. The display area is thus arranged between the see-through region and the lower edge of the windscreen. In the case of a frame-like masking region in the circumferential edge region of the windscreen, a section of the masking region in each case adjoins each edge (upper edge, lower edge, first and second side edges) and the display area is preferably arranged in the section adjoining the lower edge.

The masking region is preferably formed by an opaque, in particular black imprintment (cover imprintment) on at least one of the surfaces of the outer pane and/or of the inner pane, particularly preferably on the interior-side surface of the outer pane. The cover imprintment typically consists of an enamel, which contains glass frits and colourants (in particular pigments) and is applied by the screen printing method and subsequently baked on. Such cover imprintments are in general use, particularly for vehicle panes. The pigment is typically a black pigment, such as pigment carbon black, aniline black, bone black, iron oxide black, spinel black and/or graphite. The cover imprintment preferably has a thickness of 5 μm to 50 μm, particularly preferably of 8 μm to 25 μm.

The masking region can alternatively be formed by an opaque polymeric film which is part of the intermediate layer and which is arranged between the reflection layer and the outer pane. In the sense of the invention, an opaque film is understood to mean a film with a light transmission in the visible spectral range of less than 5%—in particular, of 0%.

The masking region can also be formed completely or partially by a functional element which has electrically controllable properties and can be darkened. Such a functional element comprises an active layer or layer sequence between two planar electrodes, by means of which an electrical voltage can be applied to the active layer (sequence) in order to adjust its optical properties. Functional elements which can be darkened so as to form an opaque masking region are in particular electrochromic functional elements and SPD functional elements (suspended particle device). The opaque masking region is present only if the functional element is present in the darkened state. The functional element can be applied to one of the surfaces of the outer pane or of the inner pane, in particular to the interior-side surface of the outer pane or to the outer surface of the inner pane. The functional element can alternatively be provided as a multilayer film and be arranged between two layers of the intermediate layer.

In a development of the invention, there are a permanent masking region which is in particular formed by a cover imprintment (alternatively by an opaque polymeric film) and a region which extends therefrom into the see-through region and is provided with a functional element with electrically controllable properties (in particular an electrochromic functional element). The display area is partially arranged in the permanent masking region and partially in the region with the said functional element. The region with the functional element, depending on the switching state, belongs to the see-through region (when the functional element has been switched to transparent) or to the masking region (when the functional element has been darkened or switched to opaque). If a display is to be generated which is arranged completely or partially in the region with the functional element, the functional element will be darkened. If, on the other hand, only a display is to be generated which is arranged in the permanent masking region, the functional element can be switched to transparent in order to increase the size of the see-through region.

The opaque element, which forms the masking region (in particular the cover imprintment, the opaque polymer film and/or the functional element with electrically controllable properties), is arranged behind the reflection layer in the viewing direction so that the latter can be irradiated by the screen. The reflection layer is thus at a shorter distance from the screen than is the opaque element.

The screen is directed at the display area and irradiates it in order to generate a display image. The area of the windscreen irradiated (or irradiatable) by the screen is thus the display area in the context of the invention. In the display area of the windscreen, a reflection layer is arranged according to the invention, which reflects the radiation of the screen in the direction of the user in order to generate the display image. The screen irradiates the display area with electromagnetic radiation in the visible spectral range in order to generate the display image which the user perceives as being in the masking region. The radiation is in particular in the spectral range of 450 nm to 650 nm, for example with the wavelengths 473 nm, 550 nm and 630 nm (RGB).

The reflection layer preferably has a reflectance with respect to the radiation of the screen of at least 10%, particularly preferably at least 15%. This is advantageous for a high intensity and good quality of the secondary display image. The reflectance is, for example, from 10% to 100% or from 15% to 30%. The reflectance describes the proportion of the total irradiated radiation that is reflected. It is indicated in % (based upon 100%-emitted radiation) or as a unitless number from 0 to 1 (normalised to the emitted radiation). It forms the reflection spectrum when plotted as a function of the wavelength. In the context of the present invention, the statements regarding reflectance relate to the reflectance measured at an angle of incidence of 65° to the interior-side surface normal, which corresponds approximately to the irradiation by conventional screens. The reflectance values relate to a reflection measurement with a light source which, within the spectral range under consideration, radiates uniformly with a normalised radiation intensity of 100%.

The reflection layer covers at least the display area. However, it can also extend beyond the display area, that is to say also cover adjacent areas of the windscreen. This can be advantageous so as not to need to position the reflection layer as exactly or to prevent display errors in the edge region of the display image, which could occur as a result of imperfect positioning of the reflection layer.

The reflection layer can be designed in different ways. In a first preferred embodiment, the reflection layer is designed as a metal-containing coating. The metal-containing coating can be applied to a surface of the outer pane or of the inner pane, for example the interior-side surface of the outer pane, the outer surface of the inner pane or the interior-side surface of the inner pane. Alternatively, the coating can be provided on a carrier film which is arranged between two layers of the thermoplastic intermediate layer. The carrier film forms a reflection film together with the coating. The carrier film is, for example, a film on the basis of polyethylene terephthalate (PET), preferably made substantially of PET, having a thickness of 20 μm to 200 μm, preferably of 25 μm to 75 μm.

The metal-containing coating can be a mirror-like metal layer which reflects substantially the entire radiation of the screen (reflectance with respect to the radiation of the screen essentially 100%). Suitable metals are, for example, silver or aluminium. Suitable layer thicknesses are, for example, from 200 nm to 5 μm, in particular from 800 nm to 1.5 μm. The metal-containing coating can alternatively be formed from a plurality of thin layers, including at least one thin layer on the basis of a metal, preferably on the basis of silver. Due to their IR-reflective and electrically conductive properties, coatings of this type are also commonly used as sun protection coatings (solar control coatings) or as heatable coatings. The at least one layer on the basis of a metal preferably contains at least 99% by weight of silver and has a thickness of, for example, 5 nm to 20 nm. Such a coating has (partially) reflective properties in the visible range so that it can serve as a reflection surface for the display system. The coating preferably also contains dielectric thin films. The desired reflection characteristics, in particular the reflectance with respect to the radiation of the screen, are achieved in particular by the choice of materials and thicknesses of the individual layers. The conductive coating can thus be suitably adjusted, which is usual in the technical field and is sufficiently known to the person skilled in the art. Dielectric layers or layer sequences are typically arranged above and below the metal layer. If the coating comprises several metal layers, each metal layer will preferably be arranged between two typically dielectric layers or layer sequences so that a dielectric layer or layer sequences is arranged between adjacent metal layers in each case. The coating is thus a thin-film stack with n metal layers and (n+1) dielectric layers or layer sequences, where n is a natural number, and wherein a metal layer and a dielectric layer or layer sequence in each case alternatingly follows a lower dielectric layer or layer sequence. Common dielectric layers of such a thin-film stack are formed, for example, on the basis of silicon nitride, silicon-metal mixed nitrides such as silicon zirconium nitride, titanium oxide, aluminium nitride, tin oxide, zinc oxide or tin-zinc mixed oxide and have a layer thickness of, for example, 3 nm to 200 nm. Also common are blocker layers which protect the metal layers against degeneration and are typically formed as very thin metal-containing layers on the basis of niobium, titanium, nickel, chromium and/or alloys thereof, with layer thicknesses of, for example, 0.1 nm to 2 nm.

In a second preferred embodiment, the reflection layer is designed as a purely dielectric coating. The dielectric coating can in turn be applied to a surface of the outer pane or of the inner pane, for example the interior-side surface of the outer pane, the outer surface of the inner pane or the interior-side surface of the inner pane. Alternatively, the coating can be provided on a carrier film (reflection film) and embedded between two layers of the intermediate layer, as has been described above in connection with the metal-containing coating. The dielectric coating is preferably a layer (for example a thin film) of a material with a refractive index (measured at 550 nm) higher than the substrate to which it is applied (outer pane, inner pane or carrier film). The layer is, for example, formed on the basis of aluminium nitride, silicon nitride, zirconium nitride, silicon-zirconium mixed nitride, zirconium oxide, tin oxide, zinc oxide, tin-zinc mixed oxide, particularly preferably on the basis of titanium oxide. The layer thickness is, for example, from 100 nm to 5 μm or from 500 nm to 2 μm. More complex multilayer coatings can also be used, in which layers with a higher refractive index (for example on the basis of titanium oxide or silicon nitride) and layers with a lower refractive index (for example on the basis of silicon oxide) are arranged alternatingly. The reflective effect is here caused by interference effects and can be adjusted very specifically by the selection of the layer thicknesses.

In a third preferred embodiment, the reflection layer is designed as a purely dielectric polymeric film which contains alternating individual layers with different refractive indices. The dielectric reflection film is preferably arranged between two layers of the intermediate layer and is thereby embedded in the intermediate layer. The film has no metal-containing coatings. It is a purely dielectric layer sequence made of polymeric layers having a higher refractive index and polymeric layers having a lower refractive index, which are arranged alternatingly. At least one of the two layer types is preferably formed on the basis of PET. The other layer type can likewise be formed on the basis of PET, wherein the different refractive indices are achieved by means of suitable additives, based upon a PET copolymer or based upon another polymer—for example, PMMA. By the alternation of layers with different refractive indices, optical interference effects are achieved, which can be suitably adjusted for the respective application (in particular by the selection of the layer thicknesses and of the refractive indices) in order to realise reflective properties within a desired spectral range. In this way, reflective properties in the visible spectral range can be achieved in order to use the film as a reflection surface for the display system according to the invention.

The screen irradiates the windscreen via the inner pane with electromagnetic radiation in the visible spectral range in order to generate the display image, which a user located in the interior of the vehicle can perceive. The screen is therefore arranged on the interior side of the windscreen and irradiates the windscreen via the interior-side surface of the inner pane. The radiation of the screen is (partially) reflected at the reflection layer.

The screen can be operated in two operating modes: in a first operating mode with a restricted viewing mode, in which the screen emits light within a first angular range, and in a second operating mode with a free or unrestricted viewing mode, in which the screen emits light within a second angular range. The first angular range is smaller than the second angular range, thereby achieving the restricted viewing mode of the first operating mode.

The user can switch between the first and second operating modes. This can be done through manual or voice-controlled input from the user. In developments, it is also conceivable that the selection of the operating mode is carried out in an automated manner by a driver assistance system, wherein, for example, switching takes place from the second operating mode to the first operating mode when the driver assistance system detects a critical situation.

The display of the display system according to the invention is provided, in particular, for a vehicle occupant and assigned to them (typically the front-seat passenger). The first angular range is preferably selected in such a way that this vehicle occupant can see the display, while another vehicle occupant (typically the driver) laterally offset to said person cannot see the display. The second angular range is preferably selected such that both said vehicle occupant and the other vehicle occupant laterally offset to said person can see the display.

The angular range over which the light is emitted determines the viewing angle of the display—that is, it determines the extent to which an observer who is laterally offset to the display area can look at this area and still be able to see the display. The radiation emanating from a point on the screen is emitted in the form of a beam cone, with the angular range indicating the expansion of the beam cone. It can be quantitatively expressed as the angle between the lateral surface of the beam cone and the surface normal of the screen (determined at the point from which the beam cone emanates). In this way, the angular range is specified within the context of the present invention as the following: it is described as the angle between the peripheral rays of the beam cone, which limit the beam cone, and the surface normal. A screen that would only emit light precisely vertically and exclusively along the surface normal and not in the form of a beam cone, would have an angular range of 0°. The further the beam cone is extended, the greater the size of the angular range.

It is possible that the light is not emitted in a rotationally symmetrical beam cone, but that the angular ranges differ in the horizontal and vertical directions. The terms “horizontal” and “vertical” refer to the representation of the display on the windscreen: the vertical angular range defines the extent of the irradiated region in the vertical dimension of the windscreen (direction between the upper edge and the lower edge of the windscreen), the horizontal angular range defines the extent of the irradiated region in the horizontal dimension of the windscreen (direction between the lateral edges). It is easy to see from the intended application that the angular range within the context of the invention refers in this case to the horizontal angular range. The angular range is described as the angle between the peripheral rays of the beam in a horizontal section, which are emitted toward the lateral edges of the windscreen, and the surface normal. The horizontal section is a section through the component of the emitted light which irradiates the windscreen along a horizontal line between its lateral edges.

The horizontal angular range can also be referred to as the lateral angular range. The lateral angular range of the screen determines the lateral angular range of the display. “Lateral” refers to the intended viewing situation, wherein the observers are arranged on the interior side of the windscreen and look onto the interior-side surface of the inner pane. The lateral angular range defines the extent to which an observer positioned laterally offset in relation to the display area can see the display. The angular range thus determines the lateral viewing angle of the display.

The angular range can be determined by an observer looking at the viewing screen and moving laterally away from it. From the position at which the observer can no longer see the display, the angular range can be determined as an angle between the surface normal of the screen and the connecting line between the said position and the edge of the screen facing it. For a comparison of angular ranges of different displays, these can be recorded, for example, using the same camera, which are moved laterally away from the screen, wherein the camera remains directed at the screen. In each case, the limit of the angular range is reached when the display can no longer be seen in the camera recording.

The first angular range typically lies within a range from 15° to 90°, for example from 15° to 60° or from 20° to 50° or from 20° to 40°. The second angular range typically lies within a range from 30° to 90°, for example from 40° to 90° or from 50° to 90° or from 60° to 80°.

The screen is in particular designed as a backlit transmissive imager. The two operating modes are achieved in particular by using two different backlights that emit light with different angular ranges. The screen can
alternatively be operated using the first or the second backlight, thus realising the two operating modes, or
either be operated with the first backlight only or with a combination of the two backlights, thus realising the two operating modes.

In a preferred embodiment, the screen comprises a first planar backlight, a second planar backlight and a transmissive imager, which are arranged surface-to-surface one above the other in the order given. The transmissive imager faces the windscreen and the first planar backlight faces away from the windscreen. The backlights are preferably at least as large as the transmissive imager so that the latter can be irradiated uniformly. One of the two backlights emits light within the first angular range and the other of the two backlights emits light within the second angular range. Since the light from the first backlight must pass through the second backlight to irradiate the transmissive imager, the second backlight is transparent. This means that the second backlight has a transmittance of at least 70% compared with the radiation of the first backlight. Likewise, the second backlight should not scatter the light of the first backlight too much—the haze value of the second backlight is therefore preferably less than 7%, particularly preferably less than 2%, measured according to ASTM D1003.

The screen is preferably operated in such a way that the two backlights are operated alternatively. This means that in the first operating mode (restricted viewing mode), only the first backlight is operated while the second backlight is switched off, and that in the second operating mode (free viewing mode), only the second backlight is operated while the first backlight is switched off. Alternatively, it is, however, also conceivable that the first backlight is operated continuously with the smaller or limited angular range. In the first operating mode, the first backlight is then the only light source, while in the second operating mode, the second backlight with the larger or unrestricted angular range is also switched on. This also achieves a free viewing mode in the second operating mode, whereby the radiation intensity is stronger in the first angular range due to the additional light source and the display in the first angular range therefore appears brighter or more intense than in the remaining portion of the second angular range (i.e. which does not overlap with the first angular range). At least the second backlight can therefore be switched on and off. Preferably, both backlights can be switched on and off separately, wherein one backlight switching on is accompanied by the other backlight switching off.

In an advantageous embodiment, the first planar backlight emits light within the first angular range and the second planar backlight emits light within the second angular range. The second operating mode is thus realised by using the second backlight, which is arranged between the first backlight and the imager. The second backlight is preferably designed as a flat light guide which is provided with a lamp suitable for coupling light into the light guide via a lateral edge, and with coupling-out means suitable for coupling the light out of the light guide via a surface facing the imager.

The flat light guide is a layered or plate-like object that is suitable for conducting light. It can also be referred to as a light guide plate and has two main surfaces and a peripheral edge surface extending therebetween, which can also be referred to as a lateral edge surface or lateral edge for short. One of the main surfaces faces the imager and the other main surface faces the first backlight. Suitable materials for the light guide include glass or transparent plastics, such as polymethyl methacrylate (PMMA), polyethylene terephthalate (PET) or polycarbonate (PC), for example. The lamp is positioned in such a way that the light emitted by the lamp is coupled into the light guide via the lateral edge (at least a portion of the lateral edge). There, the light propagates as a result of total reflection at the main surface of the light guide, which forms the basis for the light-conducting effect. The lamp is, for example, a light-emitting diode or a plurality of light-emitting diodes which is/are positioned on the lateral edge of the light guide. The light guide is equipped with coupling-out means which cause the light to be coupled out of the light guide via the surface facing the imager and to then irradiate the imager. This does not mean that all of the light must be coupled out via this main surface alone—typically, a certain proportion of the light is coupled out via the opposite main surface facing the first backlight. This is not a problem, although this light proportion then naturally does not contribute to the backlight of the imager and is lost so-to-speak. It is therefore advantageous if as large a proportion of the light as possible is coupled out via the main surface facing the imager. The coupling-out means can, for example, be designed as light-scattering structures which are formed on one of the main surfaces of the light guide and/or are embedded in the light guide. An example of this is local or full-surface roughening or structuring of at least one of the main surfaces, which prevents total reflection and therefore leads to the light being coupled out. The roughening or structuring is preferably provided on the main surface of the light guide that faces the imager in order to optimise emission in this direction. Instead of roughening, microlenses, microprisms or diffractive structures (such as holograms or diffraction gratings) can be applied to or formed on the main surface, for example. These elements can, for example, be applied to the main surface as prefabricated elements, for example by gluing them on, be formed from a UV-curing or thermally curing varnish that is applied to the main surface, be structured or shaped using a tool and then cured, or be formed from the main surface of the light guide itself by machining it with a tool. Nanoparticles, for example, can be embedded in the light guide as embedded coupling-out means, especially if the light guide consists of a polymeric material, preferably with particle sizes of 150 nm to 500 nm.

The first backlight preferably comprises a planar base element (lighting element, planar light emitter) which emits the light, and a micro-louvre film which causes the emission angle to be restricted to the first angular range. The micro-louvre film is arranged between the base element and the second backlight, preferably applied to the main surface of the base element which faces the second backlight. The micro-louvre film is a polymeric film in which parallel louvres with widths and interspaces in the micrometre range are formed, which restrict the angular range of the light passing through. The angular range can be adjusted by means of the depth of the lamellae and the interspaces of adjacent lamellae. Such micro-louvre films are known per se and are used, for example, as privacy filters on notebook monitors. In order to limit the lateral angular range of the display, the micro-louvre film is arranged in such a way that the projection of the louvres onto the windscreen extends substantially vertically between the upper edge and the lower edge of the windscreen.

The base element, similarly to the second backlight, can be designed as a flat light guide which is provided with a lamp suitable for coupling light into the light guide via a lateral edge, and with coupling-out means suitable for coupling the light out of the light guide via a surface facing the imager. For the first backlight, the lamps can also be arranged on the main surface of the light guide facing away from the imager instead of on the lateral edge. Alternatively, electroluminescent films, cold cathode tubes, LED panels (two-dimensional LED arrays), planar OLED emitters or other floodlights can be used as the base element, for example.

The first backlight can comprise further elements which are well known to those skilled in the art, for example a diffuser, one or more light collimators or optical filters. For example, the first backlight can be constructed from the following elements in the order given: base element—diffuser—light collimator(s)—micro-louvre filter.

The transmissive imager converts the light of the backlight into the desired display, which is then projected onto the windscreen. The imager thus supplies the light of the backlights with information, as it were, when the light passes through it. The transmissive imager is preferably a liquid crystal display element (LCD panel).

In a particularly advantageous embodiment, the radiation of the screen impinging on the windscreen is p-polarised. The radiation is in particular substantially purely p-polarised—the p-polarised radiation component is thus 100% or deviates only insignificantly therefrom. The indication of the polarisation direction here refers to the plane of incidence of the radiation on the windscreen. P-polarised radiation refers to a radiation, the electric field of which oscillates in the plane of incidence. S-polarised radiation refers to a radiation, the electric field of which oscillates perpendicular to the plane of incidence. The plane of incidence is spanned by the vector of incidence and the surface normal of the windscreen. The polarisation, i.e. in particular, the proportion of p- and s-polarised radiation, is determined at a point of the display area, preferably at the geometric centre of the display area. If the windscreen is curved, which is usually the case, this has an effect on the plane of incidence of the radiation. For this reason, polarisation components slightly deviating therefrom can occur in the other regions, which is unavoidable for physical reasons. For providing the p-polarised radiation, a polarisation filter or a polarising beam splitter can, for example, be arranged in the beam path between the screen and the windscreen.

The radiation of the screen preferably impinges on the windscreen at an angle of incidence of 45° to 70°, in particular 60° to 70°. In an advantageous embodiment, the angle of incidence deviates by at most 10° from the Brewster angle. The p-polarised radiation is then reflected only insignificantly at the surfaces of the windscreen. As a result, the reflection layer represents the only significant reflection surface for the radiation. If the radiation were also to be significantly reflected at the interior-side surface of the inner pane (air-glass transition), a so-called ghost image would arise, which would be at least disturbing for the user, if not entirely unacceptable. The angle of incidence is the angle between the vector of incidence of the radiation and the interior-side surface normal (that is to say the surface normal on the interior-side external surface of the windscreen) at the geometric centre of the display area. The Brewster angle for an air-glass transition in the case of soda-lime glass, which is generally common for window panes, is 57.2°. Ideally, the angle of incidence should be as close as possible to this Brewster angle. However, angles of incidence of 65°, for example, can also be used, which are common for HUD projection arrangements, are easy to implement in vehicles and deviate only slightly from the Brewster angle, so that the reflection of the p-polarised radiation increases only insignificantly.

The windscreen has at least one display area comprising the screen according to the invention having the two operating modes. The windscreen can also have one or more further display areas, specifically one or more display areas according to the invention (each irradiated by a screen according to the invention having the two operating modes) and/or one or more conventional display areas (each irradiated by a conventional screen having just the one operating mode). In an advantageous design, all the display areas according to the invention are assigned to the passenger.

The windscreen is preferably curved in one or more spatial directions, as is common in particular for motor vehicle panes. Typical radii of curvature are in the range of about 10 cm to about 40 m. The interior-side surface of the inner pane is generally concavely curved, and the outer-side surface of the outer pane is generally convexly curved. In principle, however, the windscreen can also be flat.

The windscreen can be produced by methods known per se. Here, a layer stack is produced by arranging the individual components (outer pane, film(s) of the intermediate layer, inner pane) flat on top of one another in the required order. This layer stack is then laminated to form a composite pane. This is carried out in particular by methods known per se—for example, by means of autoclave methods, vacuum bag methods, vacuum ring methods, calender methods, vacuum laminators, or combinations thereof. The outer pane and inner pane are usually connected via the intermediate layer under the effect of heat, vacuum and/or pressure.

If the reflection layer is a coating on the outer pane or the inner pane, this coating will preferably be applied to the respective pane surface by physical vapour deposition (PVD), particularly preferably by cathode sputtering, very particularly preferably by magnetic-field-assisted cathode sputtering (“magnetron sputtering”). In principle, however, the coating can also be applied, for example, by means of chemical vapour deposition (CVD), plasma-enhanced chemical vapour deposition (PECVD), by vapour deposition, or by atomic layer deposition (ALD). The reflection layer is preferably applied to the pane surface before the panes are connected to form the composite pane (lamination).

If, on the other hand, the reflection layer is provided as a reflection film (metal-containing or purely dielectric coating on a carrier film or purely dielectric polymeric film), it will be arranged between two thermoplastic connecting layers and with them form the intermediate layer. The connecting layers are preferably provided in each case in the form of at least one thermoplastic connecting film (in particular PVB film). The reflection films can generally be purchased, for example as PET carrier film with an electrically conductive coating or as a purely dielectric reflection film with different individual layers, which alternatingly have a higher and a lower refractive index. They can be produced by deposition of an electrically conductive coating or purely dielectric coating on a PET carrier film, in particular with the aforementioned thin-film coating methods, or by coextrusion or multi-extrusion of two materials with different refractive indices in order to form a purely dielectric reflection film.

The masking region can be formed by an opaque enamel printing ink being applied to a surface of the panes, in particular the interior-side surface of the outer pane, in particular by means of a screen printing method. The enamel printing ink is then baked into the pane surface, wherein it forms an opaque cover imprintment which forms the masking region. Alternatively, the masking region can be formed by an opaque polymeric film. In this case, one of the connecting layers is not formed by a single homogeneous connecting film but is composed of a section of an opaque connecting film and a section of a transparent connecting film. The connecting layer with the opaque connecting film is arranged between the reflection layer and the outer pane. If the masking region (or at least a part thereof) is formed by a functional element with electrically switchable optical properties, the layer system necessary for this purpose will be applied either before lamination on one of the surfaces of the outer pane or of the inner pane, or the functional element will be provided as a prefabricated multilayer film and inserted before lamination between two connecting layers.

If the windscreen is to be curved, the outer pane and the inner pane will be preferably subjected to a bending process before lamination and preferably after possible coating processes, in order to bring them into a cylindrically or spherically curved shape. Preferably, the outer pane and the inner pane are curved together congruently (i.e. simultaneously and by the same tool) because this optimally matches the shape of the panes to one another for the subsequent lamination. Typical temperatures for glass-bending processes are, for example, 500 °C to 700 °C. At these temperatures, the glass panes become plastically deformable and can be brought into the desired shape by bending methods known per se, for example gravity bending, press bending, suction bending or combinations thereof.

The invention also comprises a vehicle which has a driver's seat and a front-seat passenger's seat and which is equipped with a display system according to the invention. The windscreen of the vehicle is used as a projection surface of the display system and is irradiated by at least one screen that can be operated in the first operating mode and in the second operating mode.

The driver's seat and the front-seat passenger's seat are in particular arranged next to one another behind the windscreen. The windscreen can be divided imaginarily into two halves by a centrally arranged dividing line that extends between the upper edge and the lower edge. One half is then assigned to the driver's seat and is arranged in front of the driver's seat (in the direction of travel), while the other half is assigned to the front-seat passenger's seat and arranged in front of the front-seat passenger's seat (in the direction of travel). If the driver and front-seat passenger are looking straight ahead in the direction of travel, each will be looking through the half of the windscreen assigned to them.

In an advantageous embodiment, the display area according to the invention is assigned to the front-seat passenger and is arranged in front of the front-seat passenger's seat. This means that the screen according to the invention having the two operating modes is provided to generate a display for the front passenger. The associated display area is therefore arranged in the half of the windscreen that is assigned to the front-seat passenger's seat and is arranged on the side of the front-seat passenger's seat. The advantages of the display system according to the invention are particularly advantageous because the front passenger can switch to the first operating mode having the restricted angular range if the driver is not to be disturbed by the display.

Several display areas can also be assigned to the front-seat passenger and be arranged in front of the front-seat passenger's seat, which in each case are irradiated by a separate screen. In this case, preferably all of the screens of the display areas assigned to the front passenger are designed according to the invention and are thus suitable for operating in the two different operating modes.

In one embodiment of the invention, there is (at least) one further display area which is assigned to the driver and is arranged in front of the driver's seat. A further screen is directed at this further display area for generating a display image by reflection at a reflection layer. Even several display areas can be assigned to the driver and be arranged in front of the driver's seat, each of which is irradiated by a separate screen.

The display area assigned to the driver can in principle also be irradiated by a screen according to the invention having the two operating modes. However, since it is less critical if the driver's displays disturb the front passenger, a conventional screen is preferably used, which is only suitable for operation in a single operating mode (i.e. with a single angular range). Since conventional screens are typically less complex and therefore less expensive, this is advantageous in terms of production costs. In said operating mode, the screen preferably emits light within the second angular range (free viewing mode) such that the front passenger can also see the driver's display. In principle, however, the screen then also emits the light within the first angular range (limited viewing mode).

Even several display areas can be assigned to the driver and be arranged in front of the driver's seat, each of which is irradiated by a separate screen. In this case, all the screens of the display areas assigned to the front passenger preferably have a conventional design and are thus only suitable for operation in a single operating mode (preferably the operating mode with the second angular range and free viewing mode).

In a development, a screen such as that in WO2019034557A1 can also be used. This screen has a first region in which it is operated in two different operating modes with different angular ranges and a second region in which it is operated in only one operating mode with a single angular range. Such a screen can be realised, for example, having a first and a second backlight, as described above, wherein the micro-louvre film for limiting the angular range is only provided in the first region of the screen. In the second region, the first backlight then also emits light with the second angular range. Such a screen can, for example, be positioned in the region of the vehicle's centre console and irradiated a display area that is partly arranged in the half of the windscreen associated with the driver's seat and partly in the half of the windscreen associated with the passenger's seat. The first region of the screen having the two operating modes then preferably irradiates the part of the display area that is in the half of the windscreen associated with the passenger's seat, and the second region of the screen having just the one operating mode then preferably irradiates the part of the display area in the half of the windscreen associated with the driver's seat.

In the display area or the display areas assigned to the front-seat passenger, entertainment contents are preferably presented, for example a television program, videos, computer games or internet data. In the display area or the display areas assigned to the driver, preference is given to displaying status information that has previously been typically displayed in the area of the dashboard, such as the time of day, driving speed, engine speed, cooling water temperature, internal or external temperature, information of the entertainment system (such as the currently used radio station) or information of a navigation system. Likewise, the picture from one or more rear-facing cameras can be displayed for the driver in order to supplement or replace the classic exterior mirrors or rearview mirrors. The display of this information in the masking region of the windscreen has the advantage that the driver does not have to turn their gaze out of the actual field of view as far as is the case with conventional displays, which is advantageous for safety reasons and for ergonomic reasons. In semi-autonomous driving, the driver can take control of the vehicle more quickly. A more flexible human-machine interface is provided, in which the user themselves can determine the position of the individual displays, for example. The semi-virtual display image allows faster re-focusing of the eyes on the roadway. In addition, the display is aesthetically pleasing.

In the following, the invention is explained in more detail with the aid of a drawing and examples of embodiments. The drawing is a schematic representation and is not true to scale. The drawing does not limit the invention in any way.

In the drawings:

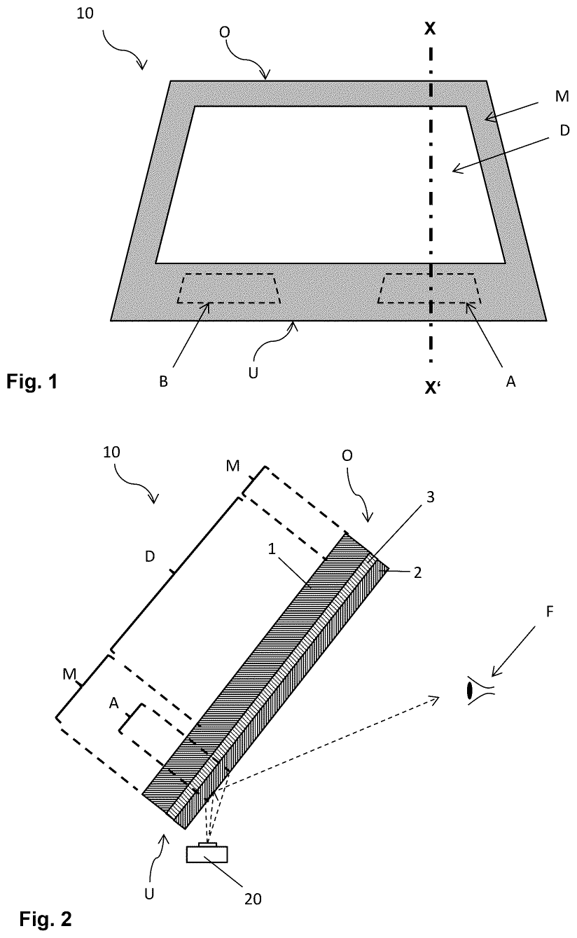

FIG. 1 is a plan view of a windscreen of a display system according to the invention in a vehicle,

FIG. 2 a cross-section through a display system according to the invention with the windscreen of FIG. 1,

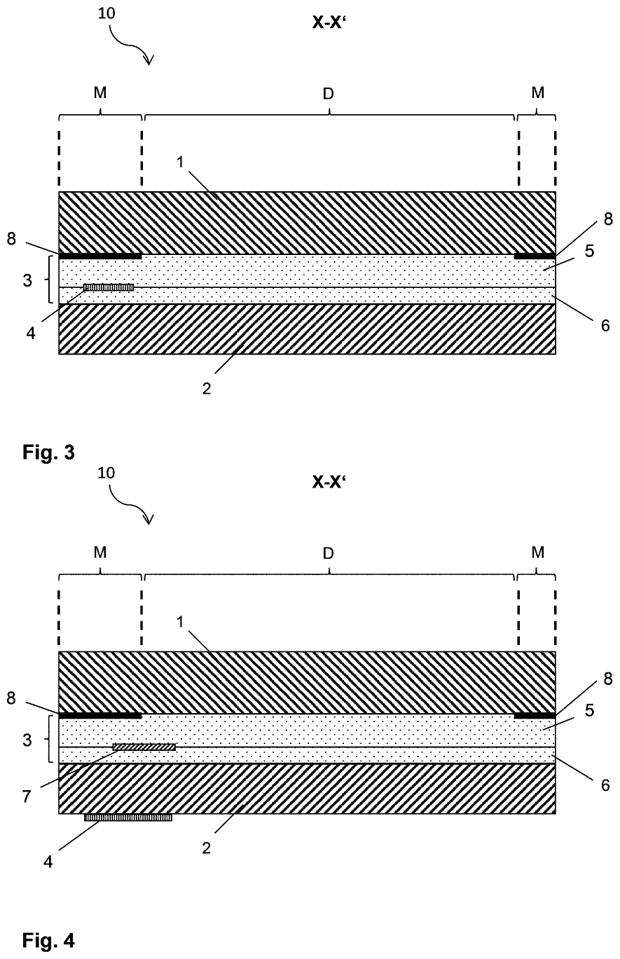

FIG. 3 is a cross section through the windscreen in FIG. 1;

FIG. 4 is a cross section through a further embodiment of the windscreen of a display system according to the invention,

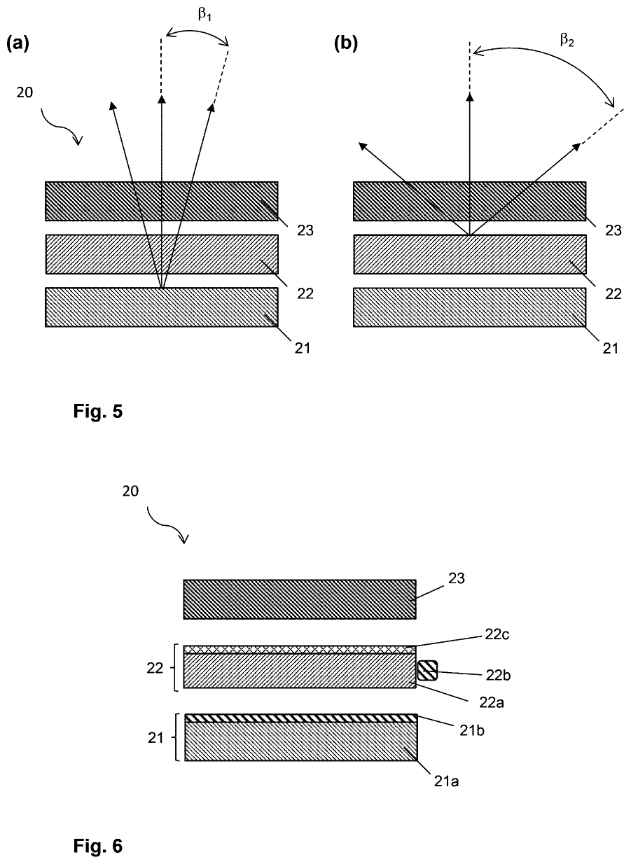

FIG. 5 is a cross section of the screen of the display system from FIG. 2, and

FIG. 6 is another cross section of the screen of the display system from FIG. 2,

FIG. 1, FIG. 2 and FIG. 3 each show a detail of a display system according to the invention in a vehicle. The display system consists of a windscreen 10 and a screen 20. FIG. 1 shows a plan view of the windscreen 10, FIG. 2 shows a cross-section through the display system along the cutting line X-X′ marked in FIG. 1, and FIG. 3 shows a cross-section through the windscreen 10 along the same cutting line with a greater number of details.

The windscreen 10 is installed in a vehicle, in particular a passenger car. FIG. 1 also shows a view of the windscreen 10 from the interior of the vehicle. The vehicle is equipped with a driver's seat and a front-seat passenger's seat. The driver's seat is arranged behind the left-hand half of the windscreen 10 in the representation, the front-seat passenger's seat behind the right-hand half. This is therefore a so-called left-hand drive vehicle for right-hand traffic, as is common in continental Europe, the USA and elsewhere. The left-hand half of the windscreen 10 is assigned to the driver and is located in front of the driver's seat, the right-hand half is assigned to the front-seat passenger and is located in front of the front-seat passenger's seat.

The windscreen 10 has an opaque masking region M, which is arranged in a circumferential edge region and surrounds a transparent see-through region D in a frame-like manner. The windscreen 10 has an upper edge O pointing upward (in the direction of the vehicle roof) and a lower edge U pointing downward (in the direction of the engine compartment) and two side edges extending between them. Such masking regions M are common in vehicle panes—they serve to protect against UV radiation the adhesive used to bond the windscreen 10 to the vehicle body. In addition, any electrical connections or the side edge of an embedded functional film can be hidden within the masking region M.

The windscreen 10 has, by way of example, two display areas A, B. The two display areas A, B are arranged in the section of the masking region M that adjoins the lower edge U. The display area A is assigned to the front-seat passenger F and is arranged in the half of the windscreen 10 located in front of them. It is intended to display a display for the front-seat passenger F. This can, in particular, be entertainment content, for example films, internet data or computer games. The display area B is assigned to the driver and is arranged in the half of the windscreen 10 located in front of them. It is intended to display a display for the driver. This can, in particular, be status information of the vehicle (for example the driving speed), navigation information or the picture from a rear-facing camera.

In order to generate the display, a screen 20 is directed at the display area A which is irradiated by said screen. The display area B is likewise irradiated by a further screen (not shown). The aim of the invention is to implement the display in the display area A in such a way that the driver is not disturbed by it. However, the driver is intended to be able to see the display in display area A if they so wish. For this purpose, according to the invention a projector 20 is used which can be operated in two different operating modes, specifically a first operating mode in which the light of the screen 20 is emitted within a smaller angular range (restricted viewing mode) and a second operating mode in which the light of the screen 20 is emitted within a larger angular range (free/unrestricted viewing mode). The driver or front passenger can set the operating mode in which the screen 20 is operated. For display area B, a conventional screen is used which is operated in only a single operating mode. This is in particular an operating mode with a larger angular range of the emitted light so that the front passenger can also see the display. The screens are arranged below the respective display areas A, B.

The windscreen 10 is constructed from an outer pane 1 and an inner pane 2, which are connected to one another via a thermoplastic intermediate layer 3. In the installed position, the outer pane 1 faces the external environment; the inner pane 2 faces the vehicle interior. For the sake of simplicity, the windscreen 10 is shown flat, although vehicle panes are usually curved, which is also preferred within the scope of the present invention. The outer pane 1 and the inner pane 2 consist of soda-lime glass. The outer pane 1 has, for example, a thickness of 2.1 mm, the inner pane 2 has a thickness of 1.6 mm.

The masking region M is formed by a black cover imprintment 8 which is applied to the interior-side surface, facing the intermediate layer 3, of the outer pane 1. In the automotive sector, such a cover imprintment 8 is generally standard: an enamel ink is printed onto the pane surface by means of screen printing. It contains a black pigment as well as glass frits which are baked into the pane surface.

The intermediate layer 3 has a multi-layered structure. It has an outer connecting layer 5 which faces the outer pane 1 and an inner connecting layer 6 which faces the inner pane 2. The connecting layers 5, 6 are transparent and made of commercially available PVB films, which also contain plasticisers. The outer connecting layer 5 has, for example, a thickness of 0.76 mm, the inner connecting layer 6 has a thickness of 0.38 mm.

A reflection layer 4, which is designed as a reflection film, is arranged between the connecting layers 5, 6. The reflection layer 4 is thus connected to the outer pane 1 via the outer connecting layer 5 and to the inner pane 2 via the inner connecting layer 6. The reflection layer 4 is arranged in the section of the masking region M adjoining the lower edge U, in such a way that it covers both display areas A, B.

The screen 20 is arranged on the interior side of the windscreen 10. The inner pane 2 of the windscreen 10 thus faces the screen 20. The screen 20 irradiates the display area A in order to generate the display image. The radiation of the screen 20, which impinges on the windscreen 10, is substantially purely p-polarised. This is achieved, for example, by arranging a polarisation filter between the screen 20 and the windscreen 10. Since the screen 20 irradiates the windscreen 10 with an angle of incidence of approximately 65°, which is close to the Brewster angle, the radiation of the screen 20 is reflected only insignificantly at the interior-side surface of the windscreen 10 facing away from the intermediate layer 3. The light of the screen 20 is reflected substantially only at the reflection layer 4 so that a clear display image is generated without any disturbing ghost images, which image can be perceived by the observer, in this case the front-seat passenger F.

The reflection layer 4 is, for example, a purely dielectric reflection film, which is in each case constructed from a sequence of individual polymeric dielectric layers, wherein the individual layers alternatingly have a higher and a lower refractive index. As a result of interference, the reflection films have reflective properties, in particular with respect to the radiation of the screen 20.

FIG. 4 shows a cross section through a further windscreen 10 which can be used for a display system according to the invention. The outer pane 1 with the cover imprintment 8, the inner pane 2, the outer connecting layer 6 and the inner connecting layer 6 are designed in the same way as in the example of FIG. 3. An electrochromic film 7 is arranged between the outer connecting layer 5 and the inner connecting layer 6, specifically in a region which extends from the marking region to the see-through region D. The electrochromic film 7 can be darkened electrically, thereby increasing the masking region M as it were. The reflection layer 4 is applied to the interior-side surface of the inner pane 2 facing away from the intermediate layer 3 and in turn covers the entire display area, which in this case is partly arranged in the static masking region M formed by the cover imprintment 8 and partly in the dynamic masking region formed by the electrochromic film 7. The reflection layer 4 is, for example, a sputtered dielectric coating consisting of a thin film of titanium oxide. Depending on the situation, the electrochromic film 7 can therefore be used to enlarge the masking region M and the display area A if a large display is to be shown and it is not necessary to be able to completely see through the actual see-through region D.

The designs of the reflection layers 4 in FIGS. 3 and 4 are only examples. Alternatively, the reflection layer 4 can be realised, for example, by a reflection film as in FIG. 3, which is provided as a PET carrier film having a coating containing metal. Alternatively, a metal-containing coating can also be applied as a reflection layer 4 to the outer surface of the inner pane 2 facing the intermediate layer 3. The reflection layer 4 can have partially reflective properties with respect to the light of the screen 20 or be designed in the manner of a mirror and reflect substantially the entire radiation.

FIG. 5 shows a cross section through the screen 20 of the display system in FIG. 2. The screen 20 is constructed from a first planar backlight 21, a second planar backlight 22 and a transmissive imager 23. These elements are arranged surface-to-surface one above the other in the given order, wherein the imager 23 faces the windscreen 10.

The imager 23 is an LCD panel which is alternatively illuminated by the first backlight 21 or the second backlight 22. The first backlight 21 emits light within a first angular rangeβ₁ and the second backlight 22 emits light within a second angular rangeβ₂. The angular rangeβ₁ is smaller than the second angular rangeβ₂. By using the first backlight 21 with the smaller angular rangeβ₁, the operating mode with the restricted viewing mode is realised (FIG. 5a), and by using the second backlight 22 with the larger angular rangeβ₂, the operating mode with the free or unrestricted viewing mode is realised (FIG. 5b).

The cross-sectional view shows a section through the component of the emitted light which irradiates the windscreen 10 along a horizontal line between its side edges. This radiation component is therefore also referred to as the horizontal component. The angular ranges β₁, β₂ are determined as angles between the peripheral rays, which laterally restrict the beam cone originating from a point in the horizontal component, and the surface normal at said point. The angular ranges define the extent to which an observer can deviate laterally from the actually intended observer position (directly in front of the display area 4) and still be able to see the display. When operating in the restricted viewing mode (FIG. 5a) with the smaller angular range β₁, the display can no longer be seen if the observer is laterally offset to the display area 4 to a comparatively small extent. This means that the driver, who is significantly laterally offset to the display area 4, cannot see the display and is therefore not disturbed or distracted thereby. When operating in the free viewing mode (FIG. 5b) with the larger angular rangeβ₂, the display can still be clearly seen even from a laterally offset position. In this case, the driver can see the display in the display area 4.

FIG. 6 shows another cross section through the screen 20 in FIG. 5 with a greater number of details. The second backlight 21 is formed from a planar light guide 22a, for example made of glass or PMMA. The light guide 22a has two main surfaces, one main surface facing the imager 23 and the other main surface facing the first backlight 21, and a lateral edge (more precisely: lateral edge surface) extending therebetween. A lamp 22b is arranged on the lateral edge, for example a plurality of LEDs, the light from which is coupled into the light guide 22a via the lateral edge when the second backlight 22 is in operation and propagates therein as a result of total reflection at the main surfaces. The main surface of the light guide 22a facing the imager 23 is provided with coupling-out means 22c, for example microprisms or diffractive structures. The coupling-out means 22c are schematically arranged over the entire main surface, but are typically only distributed over evenly distributed locally restricted regions. By means of the coupling-out means 22c, the light is (partially) coupled out of the light guide 22a via the main surface facing the imager 23, as a result of which the imager 23 is backlit.

The first backlight 21 is formed from a planar lighting element 21a (base element, planar spotlight). The lighting element 21a can, for example, be formed from a light guide in a similar manner to the first backlight, via the lateral edge of which light guide light from a lamp is coupled in, wherein the light is coupled out again via the main surface by coupling-out means. However, other designs are also conceivable, such as electroluminescent films, OLEDs or LED arrangements. A micro-louvre film 21b is applied to the main surface of the base element 21a facing the second backlight 22 so as to effectuate the restricted angular rangeβ₁ of the first backlight 21.

The screen can contain further components (not shown), for example components for beam shaping (such as collimators and/or diffusers) or optical filters (in particular interference coatings) or other coatings (for example anti-reflective coatings).

### LIST OF REFERENCE SIGNS

(10) Windscreen
(1) Outer pane
(2) Inner pane
(3) Thermoplastic intermediate layer
(4) Reflection layer
(5) Outer connecting layer of the intermediate layer 3
(6) Inner connecting layer of the intermediate layer 3
(7) Electrochromic film
(8) Cover imprintment
(20) Screen
(22) First planar backlight of the screen 20
(21a) Lighting element of the first planar backlight 21
(21b) Micro-louvre film of the first planar backlight 21
(22) Second planar backlight of the screen 20
(22a) Planar light guide of the second planar flat backlight 22
(22b) Lamp of the second planar backlight 22
(22c) Coupling-out means of the second planar backlight 22
(23) Transmissive imager of the screen 20
(F) Observer/front passenger
(M) Masking region of the windscreen 10
(D) See-through region of the windscreen 10
(A) Display area of the windscreen 10 (with two operating modes)
(B) Further display area of the windscreen 10 (with one operating mode)
(O) Upper edge of the windscreen 10
(U) Lower edge of the windscreen 10
(1) First angular range of the screen 20
(B2) Second angular range of the screen 20
X-X′ Section line

1. A display system for a vehicle, comprising:
a windscreen having a transparent see-through region and an opaque masking region, and
a screen which is directed at a display area arranged in the masking region,
wherein the windscreen is equipped in the display area with a reflection layer which is suitable for reflecting the radiation of the screen in order to generate a display image,
and
wherein the screen is suitable for operation in a first operating mode and in a second operating mode, wherein the screen emits light within a first angular range in the first operating mode and emits light within a second angular range in the second operating mode,
wherein the first angular range is smaller than the second angular range.

2. The display system according to claim 1, wherein the screen comprises
a first planar backlight,
a second planar backlight, and
a transmissive imager,
which are arranged surface-to-surface one above the other in the order given,
wherein one of the first and second planar backlights emits light within the first angular range and the other of the two backlights emits light within the second angular range.

3. The display system according to claim 2, wherein
the first planar backlight emits light within the first angular range, and
the second planar backlight emits light within the second angular range and is designed as a planar light guide which is provided with a lighting means suitable for coupling light into the light guide via a lateral edge, and with coupling-out means suitable for coupling the light out of the light guide via a surface facing the imager.

4. The display system according to claim 2, wherein the transmissive imager is designed as a liquid crystal display element.

5. The display system according to claim 2, wherein the first planar backlight comprises a planar lighting element and a micro-louvre film arranged between the lighting element and the second planar backlight.

6. The display system according to claim 1, wherein the reflection layer is designed as
a metal-containing coating, or
a purely dielectric coating, or
a purely dielectric polymeric film which contains alternating individual layers with different refractive indices.

7. The display system according to claim 1, wherein the masking region is formed
by a cover imprintment,
by an opaque polymeric film as part of the intermediate layer, and/or
by a functional element having electrically controllable properties.

8. The display system according to claim 1, wherein
the windscreen has an upper edge, a lower edge, and two lateral edges extending therebetween, and
the display area is arranged in the portion of the masking region adjoining the lower edge.

9. The display system according to claim 1, wherein the radiation of the screen impinging on the windscreen is p-polarised.

10. The display system according to claim 1, wherein the windscreen is a composite pane composed of an outer pane and an inner pane, which are connected to one another via a thermoplastic intermediate layer.

11. A vehicle having a driver's seat and a front passenger's seat and equipped with a display system according to claim 1.

12. The vehicle according to claim 11, wherein the display area is arranged in the half of the windscreen that is located on the front passenger seat side.

13. The vehicle according to claim 12, wherein the angular range is selected in such a way that the display of the display area is not perceptible from the driver's seat.

14. The method according to claim 12, wherein
a further display area is arranged in the half of the windscreen that is located on the front passenger seat side,
another screen is directed at the further display area, and
the further screen is only suitable for operation in a single operating mode.

15. The display system according to claim 7, wherein functional element having electrically controllable properties is an electrochromic functional element.

16. The method according to claim 14, wherein the screen emits light within the second angular range.
